(19) United States
(12) Patent Application Publication
(10) Pub. No.: US 2022/0355811 A1
(43) Pub. Date: Nov. 10, 2022

(54) PORTABLE DEVICE, IN-VEHICLE DEVICE, AND COMMUNICATION SYSTEM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Shota Ushiro, Yokkaichi-shi, Mie (JP)

(21) Appl. No.: 17/619,761

(22) PCT Filed: Jun. 3, 2020
(86) PCT No.: PCT/JP2020/021861

§ 371 Date: Dec. 16, 2021

(30) Foreign Application Priority Data
Jun. 19, 2019 (JP) 2019-113526

(51) Int. Cl. B60W 50/08; B60W 40/09; H04W 4/48

(52) U.S. Cl. CPC B60W 50/082; B60W 40/09; H04W 4/48; B60W 2540/215

(57) ABSTRACT

An in-vehicle device easily switches settings based on which in-vehicle equipment operates. A portable device includes a mode acquisition unit and a radio-wave transmission unit. The mode acquisition unit is a processing unit configured to specify one mode from among a plurality of modes and output mode information that is information indicating the one specified mode. The radio-wave transmission unit is a processing unit configured to transmit the mode information to the in-vehicle device using a radio wave.

### CROSS-REFERENCE TO RELATED APPLICATIONS

This application is the U.S. national stage of PCT/JP2020/021861 filed on Jun. 3, 2020, which claims priority of Japanese Patent Application No. JP 2019-113526 filed on Jun. 19, 2019, the contents of which are incorporated herein.

### TECHNICAL FIELD

The present disclosure relates to a portable device, an in-vehicle device, and a communication system.

### BACKGROUND

JP 2010-216135A discloses a technique in which functions of an electronic key are changed using an authorized mechanical key housed inside the main body of the electronic key.

In a case in which a vehicle is used by a plurality of users, it can be envisioned that there would be situations in which it is desirable for a setting of in-vehicle equipment to differ depending on the user. For example, it is desirable that the driver's seat be set at a different position depending on the user. From this perspective, it is desirable that a setting based on which in-vehicle equipment operates be switched, rather than electronic key functions being switched.

In view of this, the present disclosure aims to provide a technique for easily switching a setting based on which in-vehicle equipment operates.

### SUMMARY

A portable device according to the present disclosure is configured to transmit a radio wave to an in-vehicle device for controlling in-vehicle equipment that operates in a plurality of modes. The portable device includes a first processing unit and a second processing unit. The first processing unit is configured to specify one mode from among the plurality of modes and output mode information that is information indicating the one specified mode. The second processing unit is configured to transmit the mode information to the in-vehicle device using the radio wave.

An in-vehicle device according to the present disclosure is installed in a vehicle and controls in-vehicle equipment that operates in a plurality of modes. The in-vehicle device includes a first processing unit and a second processing unit. The first processing unit is configured to receive a radio wave including mode information, extract the mode information from the radio wave, and provide the mode information to the second processing unit. The mode information is information indicating one mode specified from among the plurality of modes. The second processing unit is configured to perform control for causing the in-vehicle equipment to operate based on the one mode indicated by the mode information.

The present disclosure can be realized not only as a portable device and an in-vehicle device including such distinctive processing units, but also as a processing method including such distinctive processing as steps or as a program for causing a computer to execute such steps. Furthermore, the present disclosure can be realized as semiconductor integrated circuits that partially or entirely realize the portable device and the in-vehicle device, or as a communication system including the portable device and the in-vehicle device.

### Advantageous Effects of Invention

According to the present disclosure, a setting based on which in-vehicle equipment operates can be switched easily.

### BRIEF DESCRIPTION OF DRAWINGS

FIG. 1 is a block diagram schematically illustrating an example of configurations of an in-vehicle device and a portable device adopted in an embodiment.

FIG. 2 includes a front view and a top view illustrating an example of the appearance of the portable device.

FIG. 3 is a front view illustrating an example of the appearance of a mechanical key.

FIG. 4 includes a top view and a side view illustrating an example of the direction in which an insertion portion is inserted into the portable device.

FIG. 5 includes a front view and a top view illustrating an example of the appearance of the portable device.

FIG. 6 includes a front view and a top view illustrating an example of the appearance of the portable device.

FIG. 7 includes a front view and a top view illustrating an example of the appearance of the portable device.

FIG. 8 is a block diagram schematically illustrating an area in which operation parameters are set.

FIG. 9 is a flowchart illustrating an example of processing executed periodically by the in-vehicle device.

FIG. 10 is a flowchart illustrating an example of processing executed by the portable device.

FIG. 11 is a flowchart illustrating an example of first processing executed by the in-vehicle device.

FIG. 12 is a flowchart illustrating an example of processing for changing a display setting in accordance with a mode.

FIG. 13 is a flowchart illustrating an example of second processing executed by the in-vehicle device.

FIG. 14 is a flowchart illustrating an example of processing for selecting a portable device.

### DETAILED DESCRIPTION OF PREFERRED EMBODIMENTS

First, embodiments of the present disclosure will be listed and described.

The present disclosure is as follows.

A portable device according to the present disclosure is configured to transmit a radio wave to an in-vehicle device for controlling in-vehicle equipment that operates in a plurality of modes, and the portable device includes a first processing unit and a second processing unit. The first processing unit is configured to specify one mode from among the plurality of modes and output mode information that is information indicating the one specified mode. The second processing unit is configured to transmit the mode information to the in-vehicle device using the radio wave.

The portable device supplies information regarding one specified mode to the in-vehicle device, and thus makes it easy for the in-vehicle device to cause the in-vehicle equipment to operate based on the mode. In other words, the portable device facilitates the switching of a setting based on which the in-vehicle equipment operates.

It is preferable that the first processing unit be configured to distinguish the plurality of modes from one another. This is because such a configuration is advantageous for varying settings between modes.

It is preferable that the first processing unit be configured to make a distinction between a guest mode, which is a default setting among the plurality of modes, and the plurality of modes other than the guest mode. Such a configuration is advantageous in that an operation for newly adjusting the in-vehicle equipment is simplified even in a case in which different guests use a vehicle as users.

Furthermore, an in-vehicle device according to the present disclosure is installed in a vehicle and controls in-vehicle equipment that operates in a plurality of modes. The in-vehicle device includes a first processing unit and a second processing unit. The first processing unit is configured to receive a radio wave including mode information, extract the mode information from the radio wave, and provide the mode information to the second processing unit. The mode information is information indicating one mode specified from among the plurality of modes. The second processing unit is configured to perform control for causing the in-vehicle equipment to operate based on the one mode indicated by the mode information.

According to such a configuration, the switching, by the in-vehicle device, of a setting based on which the in-vehicle equipment operates is facilitated by the portable device.

It is preferable that the plurality of modes include a guest mode, which is a default setting among the plurality of modes, and an owner mode that is different from the guest mode, and parameters based on which the in-vehicle equipment operates be set so that the number of first items that can be changed in the guest mode is less than the number of second items that can be changed in the owner mode. This is because the superiority of the owner mode over the guest mode can be obtained.

In terms of the superiority, it is further preferable that all of the first items be included among the second items.

Also, it is preferable that a communication system including the portable device according to the present disclosure and the in-vehicle device according to the present disclosure be obtained.

Specific examples of the portable device, the in-vehicle device, and the communication system according to the present disclosure will be described in the following with reference to the drawings. Note that the present disclosure is not limited to these examples, and is intended to include all modifications that are indicated by the claims and are within the meaning and scope of equivalents of the claims. At least some of the embodiments described in the following may be combined as desired.

### EMBODIMENT

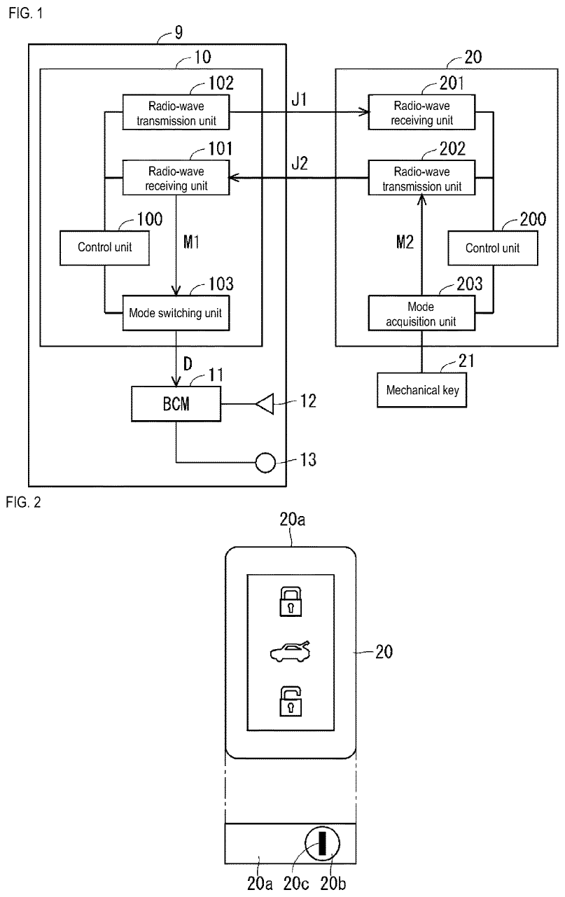

An embodiment will be described in the following. FIG. 1 is a block diagram schematically illustrating an example of configurations of an in-vehicle device 10 and a portable device 20 adopted in the present embodiment.

The in-vehicle device 10 is installed in a vehicle 9. A body control module 11, a car navigation system 12, and an actuator 13 are installed in the vehicle 9. The actuator 13 is employed in a motor for setting a seat position, for example.

At least one of the car navigation system 12 and the actuator 13 corresponds to in-vehicle equipment that operates in a plurality of modes. In the following, an owner mode and a guest mode will be described as examples of the plurality of modes. In the following, a case in which both the car navigation system 12 and the actuator 13 operate in a plurality of modes will be described as an example.

However, the car navigation system 12 and the actuator 13 operate in the same mode. When the car navigation system 12 operates in the owner mode, the actuator 13 also operates in the owner mode, and when the actuator 13 operates in the owner mode, the car navigation system 12 also operates in the owner mode. When the car navigation system 12 operates in the guest mode, the actuator 13 also operates in the guest mode, and when the actuator 13 operates in the guest mode, the car navigation system 12 also operates in the guest mode.

For example, the owner mode is adopted as the mode in which the car navigation system 12 and the actuator 13 operate when an owner of the vehicle 9 drives the vehicle 9, and the guest mode is adopted as the mode in which the car navigation system 12 and the actuator 13 operate when a guest drives the vehicle 9.

The concept of “guest” is used to indicate users other than the owner. For example, a plurality of different users may each be a “guest” if car sharing is performed.

The body control module 11 receives a mode signal D that indicates the mode. The body control module 11 causes the car navigation system 12 and the actuator 13 to operate in either the owner mode or the guest mode based on information included in the mode signal D. In the following, an integer value is described as an example of the information that is included in the mode signal D and that indicates the mode.

The in-vehicle device 10 includes a control unit 100, a radio-wave receiving unit 101, a radio-wave transmission unit 102, and a mode switching unit 103. The control unit 100 controls the functions of each of the radio-wave receiving unit 101, the radio-wave transmission unit 102, and the mode switching unit 103, and also controls the radio-wave receiving unit 101, the radio-wave transmission unit 102, and the mode switching unit 103 so that they operate in cooperation with each other.

The portable device 20 includes a control unit 200, a radio-wave receiving unit 201, a radio-wave transmission unit 202, and a mode acquisition unit 203. The control unit 200 controls the functions of each of the radio-wave receiving unit 201, the radio-wave transmission unit 202, and the mode acquisition unit 203, and also controls the radio-wave receiving unit 201, the radio-wave transmission unit 202, and the mode acquisition unit 203 so that they operate in cooperation with each other. A mechanical key 21 can be attached to and detached from the portable device 20, or more specifically the mode acquisition unit 203.

The mode acquisition unit 203 acquires the owner mode as the above-described mode when the mechanical key 21 is attached to the portable device 20. The mode acquisition unit 203 acquires the guest mode as the above-described mode when the mechanical key 21 is not attached to the portable device 20.

Relationship between Portable Device 20 and Mechanical Key 21

FIG. 2 includes a front view and a top view illustrating an example of the appearance of the portable device 20. In FIG. 2, the front view is illustrated above the top view on the sheet. The portable device 20 has a top surface 20a. A top surface of a cylinder 20b is exposed on the top surface 20a. The cylinder 20b is provided inside the portable device 20. The cylinder 20b has a keyhole 20c. In the state illustrated in FIG. 2, the keyhole 20c is positioned in parallel with the direction from the front surface of the portable device 20 to the top surface 20a (the top-bottom direction in the drawing).

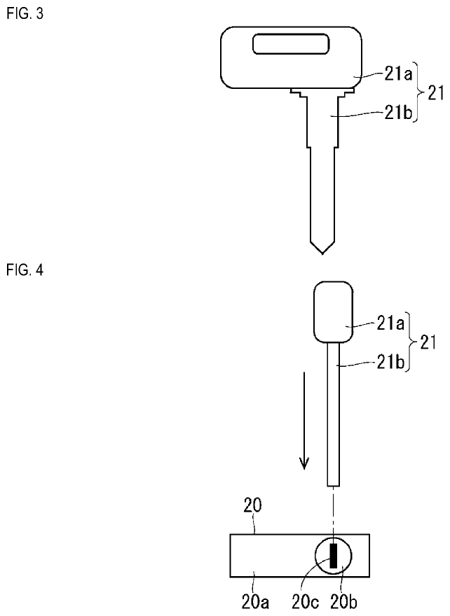

FIG. 3 is a front view illustrating an example of the appearance of the mechanical key 21. The mechanical key 21 includes a grip portion 21a and an insertion portion 21b. The insertion portion 21b can be inserted into the keyhole 20c. The cylinder 20b can rotate when the keyhole 20c and the insertion portion 21b are in a predetermined relationship, e.g., a relationship in which the keyhole 20c and the insertion portion 21b fit to one another, and when the insertion portion 21b is inserted into the keyhole 20c. The axis of this rotation is the normal direction of the top surface 20a, for example. This rotation can be realized by adopting the configuration of a cylinder lock, for example.

FIG. 4 includes a top view and a side view illustrating an example of the direction in which the insertion portion 21b is inserted into the portable device 20. In FIG. 4, the mechanical key 21 is illustrated in a side view and the portable device 20 is illustrated in a top view. The insertion portion 21b is inserted into the keyhole 20c in the direction indicated by the arrow, along the dotted and dashed line.

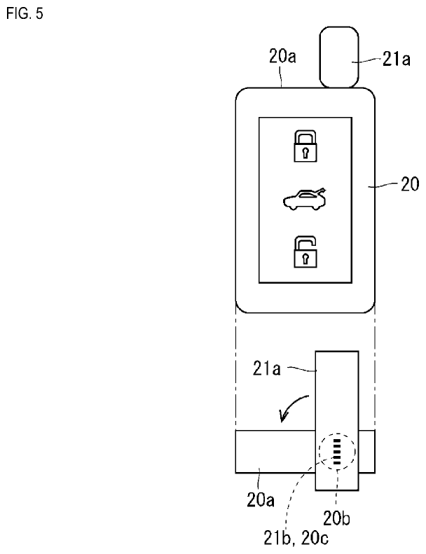

FIG. 5 includes a front view and a top view illustrating an example of the appearance of the portable device 20 after the insertion portion 21b has been inserted from the state illustrated in FIG. 4. In FIG. 5, the front view is illustrated above the top view on the sheet. In this state, the entire grip portion 21a projects from the portable device 20. A side surface of the grip portion 21a is also illustrated in the front view in FIG. 5. In the top view in FIG. 5, the cylinder 20b, the keyhole 20c, and the insertion portion 21b inserted into the keyhole 20c are illustrated using broken lines, considering that a part of the top surface 20a is concealed by the grip portion 21a. When the predetermined relationship described above is obtained, the grip portion 21a can be rotated in the counterclockwise direction in a top view from this state.

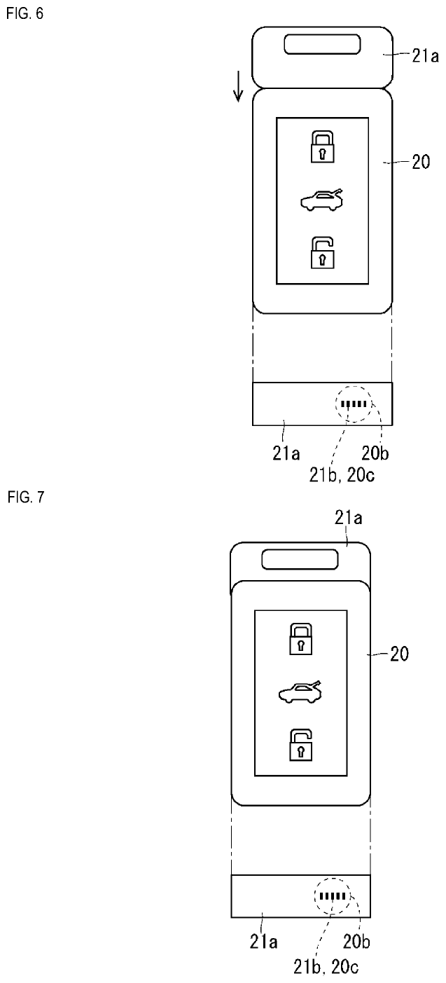

FIG. 6 includes a front view and a top view illustrating an example of the appearance of the portable device 20 in a state after the grip portion 21a has been rotated from the state illustrated in FIG. 5. In FIG. 6, the front view is illustrated above the top view on the sheet. The front surface of the grip portion 21a is also illustrated in the front view in FIG. 6. In the top view in FIG. 6, the cylinder 20b, the keyhole 20c, and the insertion portion 21b inserted into the keyhole 20c are illustrated using broken lines, considering that the top surface 20a (see FIG. 5) is concealed by the grip portion 21a. From this state, a portion of the grip portion 21a can be pushed into the portable device 20 along the direction indicated by the arrow.

FIG. 7 includes a front view and a top view illustrating an example of the appearance of the portable device 20 in a state after the grip portion 21a has been pushed in from the state illustrated in FIG. 6. In FIG. 7, the front view is illustrated above the top view on the sheet. In the top view in FIG. 7, the cylinder 20b, the keyhole 20c, and the insertion portion 21b inserted into the keyhole 20c are illustrated using broken lines, considering that the top surface 20a (see FIG. 5) is concealed by the grip portion 21a.

When the insertion portion 21b is inserted into the keyhole 20c, the cylinder 20b rotates, and the grip portion 21a is pushed into the portable device 20 as illustrated in FIGS. 4 to 7, the portable device 20 specifies the owner mode as the mode. In a state in which the mechanical key 21 is not attached to the portable device 20 as illustrated in FIG. 2, the portable device 20 specifies the guest mode as the mode.

Such mode specification can be realized using a switch that opens and closes in response to the cylinder 20b rotating, for example. The switch may open and close in response to the rotation of the cylinder 20b being detected mechanically, or may open and close in response to the rotation of the cylinder 20b being detected magnetically.

The mode acquisition unit 203 acquires the owner mode or the guest mode as the mode based on whether or not the mechanical key 21 is attached. For example, the mode acquisition unit 203 may acquire the mode while making a distinction between the owner mode and the guest mode by detecting whether the above-described switch is open or closed. The type of mode acquired by the mode acquisition unit 203 is output by the mode acquisition unit 203 as mode information M2.

It can be said that the mode acquisition unit 203 is a processing unit that is configured to distinguish a plurality of modes (the owner mode and the guest mode in this example) from one another, specify one mode (the owner mode or the guest mode in this example) from among the plurality of modes, and output information (mode information M2 in this example) that indicates the specified mode. Such distinction of modes is advantageous for varying settings between modes, and moreover, is favorable in that in-vehicle equipment operates based on a setting that corresponds to the user using the vehicle 9.

### Transmission and Reception of Mode Information

A radio wave J1 is transmitted by the radio-wave transmission unit 102 and received by the radio-wave receiving unit 201, and a radio wave J2 is transmitted by the radio-wave transmission unit 202 and received by the radio-wave receiving unit 101 (refer to FIG. 1).

The mode information M2 is transmitted using the radio wave J2. It can be said that the radio wave J2 includes the mode information M2. It can be said that the radio-wave transmission unit 202 is a processing unit that is configured to transmit the mode information M2 to the in-vehicle device 10 using the radio wave J2.

The radio-wave receiving unit 101 is a processing unit that extracts mode information M1 from the radio wave J2 and provides the mode information M1 to the mode switching unit 103. When the mode information M2 is transmitted from the portable device 20 using the radio wave J2, the radio-wave receiving unit 101 receives the radio wave J2 and extracts the mode information M2 as the mode information M1.

The mode information M1 is provided to the mode switching unit 103, and the mode switching unit 103 generates the mode signal D based on the mode information M1 and outputs the mode signal D to the body control module 11.

It can be said that the mode switching unit 103 is a processing unit that is configured to perform control for causing the car navigation system 12 and the actuator 13 to operate in the one mode indicated by the mode information M1 via the body control module 11.

In this way, the mode information M2 is transmitted from the portable device 20 using the radio wave J2, and the mode information M1 is extracted from the radio wave J2 by the in-vehicle device 10. In the in-vehicle device 10, the mode signal D is generated from the mode information M1. The body control module 11 receives the mode signal D, and causes the car navigation system 12 and the actuator 13 to operate in the one mode based on the mode signal D.

The portable device 20 supplies information regarding one specified mode to the in-vehicle device 10, and thus makes it easy for the in-vehicle device 10 to cause in-vehicle equipment, such as the car navigation system 12 and the actuator 13, to operate based on the mode. In other words, the portable device 20 makes it easy for the in-vehicle device 10 to switch a setting based on which in-vehicle equipment operates.

In particular, the portable device 20 (more specifically, the mode acquisition unit 203) specifies the owner mode or the guest mode in accordance with whether or not the mechanical key 21 is attached. Accordingly, when an owner of the mechanical key 21 (typically the owner of the vehicle 9) allows another person to use the portable device 20, the owner can determine the mode to be adopted when the other person uses the vehicle 9 by either lending the mechanical key 21 to the other person or not lending the mechanical key 21 to the other person.

The in-vehicle device 10 controls operations performed by the car navigation system 12 and the actuator 13 based on the mode information M2 obtained from the portable device 20 as the mode information M1. The portable device 20 can be used to vary, depending on the user, the settings that the operations performed by the in-vehicle equipment are based on.

When the mode information M1 indicates the owner mode, the actuator 13 moves the driver's seat to a position suitable for seating the owner of the vehicle 9, for example. Such an operation of the actuator 13 is advantageous to alleviate the necessity of the owner 9 having to newly adjust the position of the driver's seat in the vehicle 9 when a guest has used the vehicle 9 before the owner.

When the mode information M1 indicates the guest mode, the actuator 13 moves the driver's seat of the vehicle 9 to a default-setting position, for example. Such an operation of the actuator 13 is advantageous in that an operation of newly adjusting the position of the vehicle driver's seat is facilitated even in a case in which different guests use the vehicle 9 as users. It is suitable to set a setting of in-vehicle equipment to a default setting in the guest mode in such a manner if the vehicle 9 is used for car sharing. In this regard, it can be said that the guest mode is a default setting among the plurality of modes.

For example, the location of the house of the owner of the vehicle 9 can be displayed on the car navigation system 12 if the mode information M1 indicates the owner mode and cannot be displayed on the car navigation system 12 if the mode information M1 indicates the guest mode. Such a difference in display is advantageous to protect the owner's privacy. For the protection of privacy, it is desirable that, if the car navigation system 12 has been used, the usage history of the car navigation system 12 can be deleted irrespective of whether the mode is the guest mode or the owner mode.

Parameters (referred to as “operation parameters” in the following) based on which in-vehicle equipment, such as the car navigation system 12 and the actuator 13, operates is set so that the number of setting items (tentatively referred to as “first items” in the following) that can be changed in the guest mode is less than the number of setting items (tentatively referred to as “second items” in the following) that can be changed in the owner mode. It can be said that the owner mode is superior to the guest mode in terms of such broadness/narrowness of the range of setting items.

### Owner Mode Superiority

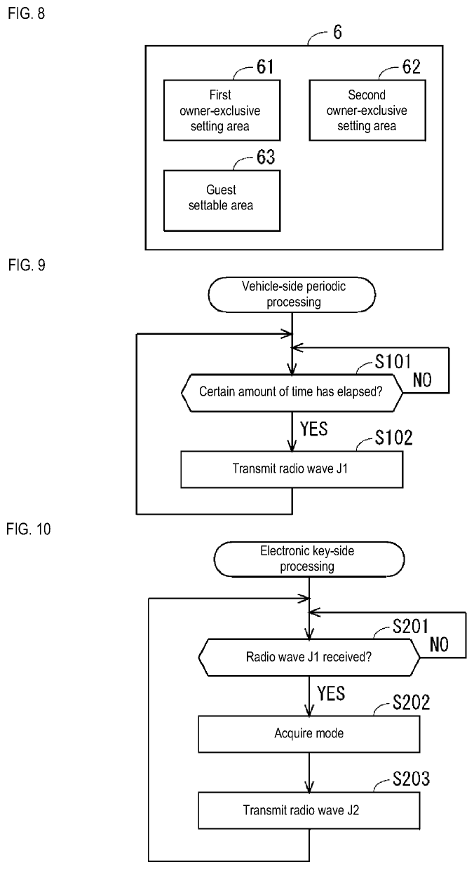

FIG. 8 is a block diagram schematically illustrating an area 6 in which the operation parameters are set. The area is realized by a storage area that is set up in a memory included in each piece of in-vehicle equipment, for example. The technique in which in-vehicle equipment operates based on the operation parameters stored in the storage area is well known, and thus the feature itself will not be described herein.

In FIG. 8, a case in which the area 6 includes a first owner-exclusive setting area 61, a second owner-exclusive setting area 62, and a guest settable area 63 is illustrated as an example. Operation parameters stored in the first owner-exclusive setting area 61 can only be changed in a first owner mode. Operation parameters stored in the second owner-exclusive setting area 62 can only be changed in a second owner mode. The guest settable area 63 can be changed in any one of the guest mode, the first owner mode, and the second owner mode. Due to the changing of operation parameters being permitted and prohibited in such a manner, all of the first items are included among the second items.

In order to vary operation parameters and store different operation parameters for multiple owners, it is advantageous for the operation parameters stored in the second owner-exclusive setting area 62 to be unchangeable in the first owner mode and the operation parameters stored in the first owner-exclusive setting area 61 to be unchangeable in the second owner mode.

It can be said that the owner modes are superior over the guest mode in that there are operation parameters that cannot be changed in the guest mode but can be changed in the owner modes. Such superiority is desirable when the vehicle 9 is used for car sharing.

The first owner mode and the second owner mode both correspond to the above-described owner mode. For example, these two owner modes are specified using different mechanical keys 21.

Second items that can be changed in the first owner mode are the operation parameters stored in the first owner-exclusive setting area 61 and the operation parameters stored in the guest settable area 63. The first items, which can be changed in the guest mode, are the operation parameters stored in the guest settable area 63, and thus the number of first items is less than the number of second items. In this case, all of the first items are included among the second items.

Second items that can be changed in the second owner mode are the operation parameters stored in the second owner-exclusive setting area 62 and the operation parameters stored in the guest settable area 63. The first items, which can be changed in the guest mode, are the operation parameters stored in the guest settable area 63, and thus the number of first items is less than the number of second items. In this case, all of the first items are included among the second items.

With regard to the operation parameters, the items listed in the following, for example, can be changed only in the owner mode and cannot be changed in the guest mode. That is, these items are stored in the first owner-exclusive setting area 61 and the second owner-exclusive setting area 62 but are not stored in the guest settable area 63.

An operation for updating or newly installing software for in-vehicle devices, such as an in-vehicle infotainment system (IVI) and the car navigation system 12: In the guest mode, not even the presence of updated software is displayed, and manual updates by the user are also disabled. However, with regard to applications, the installation of applications may be permitted with the installation destination limited to the guest settable area 63. In this case, it is desirable that the applications be distributed by reliable websites.

Setting of a function for storing data in a drive recorder: This measure is adopted since the storage of data at a high resolution and high rate reduces the residual capacity of the data storage area. Also, this measure is adopted so that data indicating the state in which the vehicle 9 was driven in the guest mode is not deleted.

### Description of Processing

FIG. 9 is a flowchart illustrating an example of processing executed periodically by the in-vehicle device 10, and the processing is indicated in an abbreviated manner as “vehicle-side periodic processing”.

In this processing, the radio-wave transmission unit 102 periodically transmits the radio wave J1. The radio wave J1 is a signal requesting the portable device 20 to provide the radio wave J2.

In step S101, it is determined whether a certain amount of time has elapsed since the radio wave J1 was transmitted in step S102. This determination is performed by the control unit 100, for example. Step S101 is terminated and step S102 is executed if an affirmative result is obtained in this determination. In step S102, the radio-wave transmission unit 102 transmits the radio wave J1. Step S102 is executed by the radio-wave transmission unit 102 based on control from the control unit 100.

If step S102 is executed, the transmission of the radio wave J1 is temporarily stopped and step S101 is executed. Step S101 is repeated if a negative determination result is obtained in step S101.

FIG. 10 is a flowchart illustrating an example of processing executed by the portable device 20. Since the portable device 20 is realized by a so-called electronic key for example, this processing is indicated in an abbreviated manner as “electronic key-side processing”.

In step S201, it is determined whether the radio wave receiving unit 201 has received the radio wave J1. This determination is performed by the control unit 200, for example. Step S201 is repeated if a negative determination result is obtained in step S201. Step S201 is terminated and step S202 is executed if an affirmative determination result is obtained in step S201.

The mode is acquired in step S202. This acquisition can be understood as the above-described mode specification. For example, the guest mode is specified as the mode if the mechanical key 21 is not attached to the portable device 20, the first owner mode is specified as the mode if a first mechanical key 21 is attached to the portable device 20, and the second owner mode is specified as the mode if a second mechanical key 21 is attached to the portable device 20. Step S202 is executed by the mode acquisition unit 203 based on control from the control unit 200.

The specified mode is output from the mode acquisition unit 203 to the radio-wave transmission unit 202 as the mode information M2. Accordingly, both processing in which the mode is specified by the mode acquisition unit 203 and processing in which the mode information M2 is output by the mode acquisition unit 203 may be included in the acquisition in step S202.

Step S203 is executed after the processing in step S202 is terminated. In step S203, the radio-wave transmission unit 202 transmits the radio wave J2. As described above, the mode information M2 is transmitted using the radio wave J2. Step S203 is executed by the radio-wave transmission unit 202 based on control from the control unit 200.

Step S201 is executed again after the processing in step S202 is terminated, and the processing in step S202 is put on stand-by until the radio wave J1 is received.

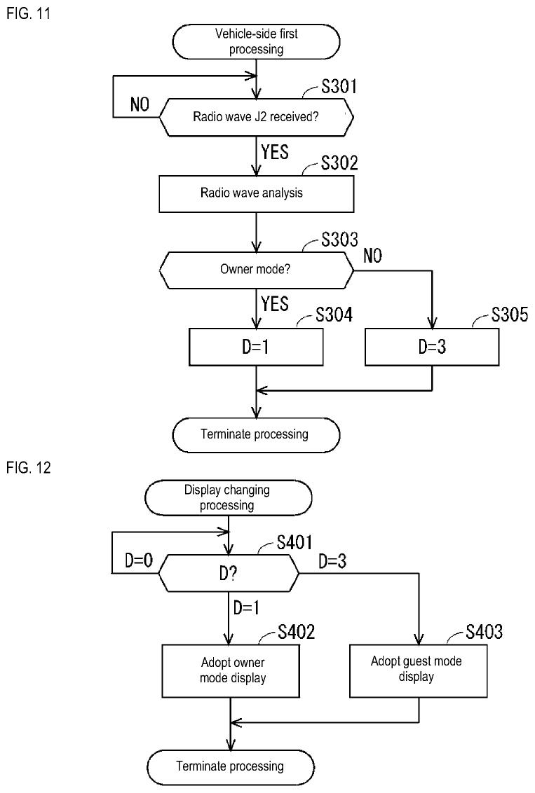

FIG. 11 is a flowchart illustrating an example of first processing executed by the in-vehicle device 10, and the processing is indicated as “vehicle-side first processing”.

In step S301, it is determined whether the radio wave receiving unit 101 has received the radio wave J2. This determination is performed by the control unit 100, for example. Step S301 is repeated if a negative determination result is obtained in step S301. Step S301 is terminated and step S302 is executed if an affirmative determination result is obtained in step S301.

In step S302, the radio wave J2 is analyzed to extract the mode information M1. This processing is indicated in an abbreviated manner as “radio-wave analysis” in FIG. 11. Step S302 is executed by the radio-wave receiving unit 101 based on control from the control unit 100.

In step S303, it is determined whether or not the mode indicated by the mode information M1 is the owner mode. While a description is provided here without distinguishing the first and second owner modes from one another, the determination may be performed so that the first and second owner modes are distinguished from one another. Step S303 is executed by the radio-wave receiving unit 101 based on control from the control unit 100.

A case in which an affirmative result is obtained in this determination corresponds to the owner mode, and step S304 is executed after step S303 is executed. A case in which a negative result is obtained in this determination corresponds to the guest mode, and step S305 is executed after step S303 is executed. Steps S304 and S305 are executed by the mode switching unit 103 based on control from the control unit 100.

In step S304, the mode signal D is provided with the value “1”. In a case in which the first and second owner modes are distinguished from one another in step S303, the mode signal D is provided with the value “1” if the mode indicated by the mode information M1 is the first owner mode, and the mode signal D is provided with the value “2” if the mode indicated by the mode information M1 is the second owner mode. When the value of the mode signal D is “1” or “2”, in-vehicle equipment installed in the vehicle 9 operates in the corresponding owner mode.

In step S305, the mode signal D is provided with the value “3”. When the value of the mode signal D is “3”, in-vehicle equipment installed in the vehicle 9 operates in the guest mode.

The first processing is terminated if step S304 or S305 is executed. However, the vehicle-side periodic processing illustrated in FIG. 9 is continuously executed.

FIG. 12 is a flowchart illustrating an example of processing for changing a display setting of the car navigation system 12 in accordance with the mode. This processing is indicated in an abbreviated manner as “display changing processing”.

In step S401, the body control module 11 determines the value of the mode signal D. If it is determined in step S401 that the value of the mode signal D is “1”, step S402 is executed after step S401 is executed. If it is determined in step S401 that the value of the mode signal D is “3”, step S403 is executed after step S401 is executed. If the value of the mode signal D is neither “1” nor “3”, step S401 is repeated. In FIG. 12, values of the mode signal D that are neither “1” nor “3” are represented by “0” in the illustration.

In step S402, based on control from the body control module 11, the car navigation system 12 adopts display in the owner mode using an operation parameter stored in the first owner-exclusive setting area 61 (or the second owner-exclusive setting area 62) in the area 6 included in the car navigation system 12. In FIG. 12, the adoption of such display is indicated in an abbreviated manner as “adopt owner mode display”.

In step S403, based on control from the body control module 11, the car navigation system 12 adopts display in the guest mode using an operation parameter stored in the guest settable area 63 in the area 6 included in the car navigation system 12. In FIG. 12, the adoption of such display is indicated in an abbreviated manner as “adopt guest mode display”.

The display changing processing is terminated if step S402 or S403 is executed. The car navigation system 12 operates by adopting the display adopted in step S402 or S403.

Similarly, the actuator 13 can also adopt operations corresponding to the owner mode and the guest mode. For example, in place of the processing in step S402, the motor for setting the seat position moves the driver's seat to the seat position in the owner mode using an operation parameter stored in the first owner-exclusive setting area 61 (or the second owner-exclusive setting area 62). For example, in place of the processing in step S403, the motor for setting the seat position moves the driver's seat to the seat position in the guest mode using an operation parameter stored in the guest settable area 63. The area 6 including the first owner-exclusive setting area 61 (or the second owner-exclusive setting area 62) and the guest settable area 63 can be provided in the body control module 11.

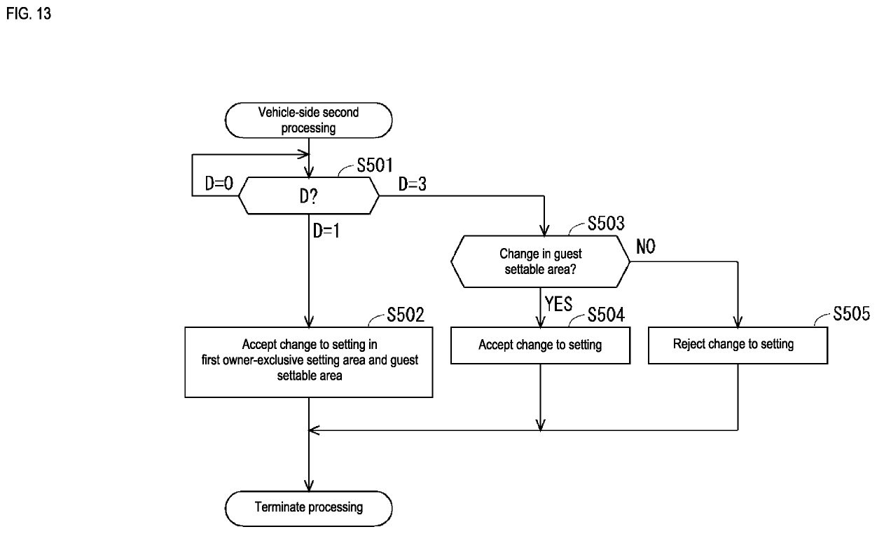

FIG. 13 is a flowchart illustrating an example of second processing executed by the in-vehicle device 10, and the processing is indicated as “vehicle-side second processing”.

In step S501, the body control module 11 determines the value of the mode signal D. If it is determined in step S501 that the value of the mode signal D is “1”, step S502 is executed after step S501 is executed. If it is determined in step S501 that the value of the mode signal D is “3”, step S503 is executed after step S501 is executed. If the value of the mode signal D is neither “1” nor “3”, step S501 is repeated. In FIG. 13, values of the mode signal D that are neither “1” nor “3” are represented by “0” in the illustration.

In step S502, a change to a setting that is a change requested by the user is accepted. In FIG. 13, a case in which the first and second owner modes are not distinguished from one another in step S502 is illustrated as an example. A case in which the value of the mode signal D is “1” corresponds to the owner mode, and thus a change to a setting in the first owner-exclusive setting area 61 (or second owner-exclusive setting area 62) and the guest settable area 63 is accepted. An operation parameter stored in these areas is changed in accordance with the change requested by the user. This change is a change to a second item.

In a case in which the first and second owner modes are distinguished from one another in steps S501 and S502, a change to a setting in the first owner-exclusive setting area 61 and the guest settable area 63 is accepted if the value of the mode signal D is “1”, and a change to a setting in the second owner-exclusive setting area 62 and the guest settable area 63 is accepted if the value of the mode signal D is “2”.

In step S503, it is determined whether the change to a setting that is a change requested by the user is a change in the guest settable area 63. If an affirmative result is obtained in this determination, the change requested by the user is accepted in step S504 after step S503 is executed, and an operation parameter stored in the guest settable area 63 is changed in accordance with the change. This change is a change to a first item.

If a negative determination result is obtained in step S503, the change requested by the user is rejected in step S505 after step S503 is executed. This rejection means that, in the guest mode, a change requested by the user is not accepted for operation parameters that are not stored in the guest settable area 63. This rejection also means that second items other than the first items are not changed in the guest mode.

The second processing is terminated if the execution of step S502, S504, or S505 is terminated. Steps S501, S502, S503, S504, and S505 are executed by the body control module 11, or by the car navigation system 12 or the actuator 13 based on control from the body control module 11.

For example, in a case in which the car navigation system 12 or the actuator 13 includes the area 6 that stores the operation parameter for which the user has made a request to change in the second processing, steps S501, S502, S503, S504, and S505 may be executed by the car navigation system 12 or the actuator 13 based on control from the body control module 11. If the body control module 11 includes the area 6, steps S501, S502, S503, S504, and S505 may be executed by the body control module 11.

### If a Plurality of Portable Devices 20 are Prepared

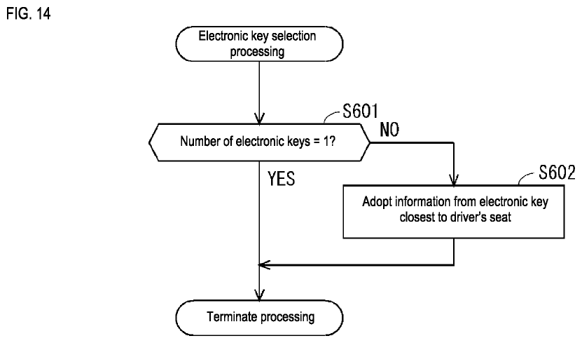

FIG. 14 is a flowchart illustrating an example of processing for selecting a portable device 20. This processing assumes a case in which a plurality of portable devices 20 are prepared for one vehicle 9. Since the portable devices 20 are realized by so-called electronic keys for example, this processing is indicated in an abbreviated manner as “electronic key selection processing”. For example, this processing is executed by the in-vehicle device 10 as a part of step S302 (refer to FIG. 11).

In step S601, it is determined whether or not a plurality of portable devices 20 have been detected. For example, if multiple types of radio waves J2 have been received in step S301, there is a possibility that radio waves J2 have been transmitted from a plurality of portable devices 20. The distinction of such radio waves J2 of multiple types received from a plurality of portable devices 20 from one another can be realized by including information unique to each portable device 20 in the radio wave J2 and by the radio-wave receiving unit 101 detecting the unique information, for example. In FIG. 14, such a determination is indicated in an abbreviated manner as “number of electronic keys=1?”.

If an affirmative result is obtained in the determination in step S601, the electronic key selection processing is terminated. Since it has been determined that there is only one portable device 20, processing based on the received radio wave J2, specifically the processing for extracting the mode information M1 from the radio wave J2 for example, is executed after the electronic key selection processing is terminated.

Step S601 is terminated and step S602 is executed if a negative result is obtained in the determination in step S601. Since radio waves J2 are received from a plurality of portable devices 20 in this case, information obtained from the portable device 20 closest to the driver's seat is adopted in step S602.

The measurement of the distance between each of a plurality of portable devices 20 and the in-vehicle device 10 is a well-known technique. Accordingly, detailed description regarding the specification of one of the plurality of portable devices 20 that is closest to the in-vehicle device 10 is omitted.

The electronic key selection processing is terminated when the execution of step S602 is terminated. Since one portable device 20 has been specified, processing based on the received radio wave J2, specifically the processing for extracting the mode information M1 from the radio wave J2 for example, is executed after the electronic key selection processing is terminated.

The control unit 100 and the mode switching unit 103 in the in-vehicle device 10, and the control unit 200 and the mode acquisition unit 203 in the portable device 20 may each be realized so as to include a computer that is configured to include a microprocessor, a read-only memory (ROM), a random access memory (RAM), etc. The radio-wave receiving units 101 and 201 may each be realized using a known receiver circuit. The radio-wave transmission units 102 and 202 may each be realized using a known transmitter circuit.

Arithmetic processing units such as microprocessors each read out, from a storage unit such as the ROM or the RAM, a computer program including some or all steps of sequence diagrams or flowcharts, such as those illustrated in FIGS. 9 to 14, and execute the computer program.

The computer programs for the plurality of devices can each be installed from an external server device or the like.

Furthermore, such computer programs are each distributed in a state in which the computer program is stored in a recording medium such as a compact disc read-only memory (CD-ROM), a digital versatile disc read-only memory (DVD-ROM), or a semiconductor memory.

### SUPPLEMENTARY NOTE

In the present disclosure, the following items may be adopted as the superiority of the owner mode over the guest mode:
changes in the guest settable area 63 can be made in the owner mode;
position information of the vehicle 9 driven in the guest mode can be (directly or indirectly) acquired in the owner mode;
the user can open a locked glove box in the owner mode but the glove box cannot be opened in the guest mode;
the ownership of the vehicle body can be changed in the owner mode but cannot be changed in the guest mode.

Note that the configurations described in the above-described embodiment and modifications can be combined, as appropriate, as long as there is no mutual contradiction.

1. A portable device configured to transmit a radio wave to an in-vehicle device for controlling in-vehicle equipment that operates in a plurality of modes, comprising
a first processing unit and a second processing unit,
wherein the first processing unit is configured to specify one mode from among the plurality of modes and output mode information that is information indicating the one specified mode, and
the second processing unit is configured to transmit the mode information to the in-vehicle device using the radio wave.

2. The portable device according to claim 1, wherein the first processing unit is configured to distinguish the plurality of modes from one another.

3. The portable device according to claim 2, wherein the first processing unit is configured to make a distinction between a guest mode, which is a default setting among the plurality of modes, and the plurality of modes other than the guest mode.

4. An in-vehicle device that is installed in a vehicle and controls in-vehicle equipment that operates in a plurality of modes, comprising
a first processing unit and a second processing unit,
wherein the first processing unit is configured to receive a radio wave including mode information, extract the mode information from the radio wave, and provide the mode information to the second processing unit,
the mode information is information indicating one mode specified from among the plurality of modes, and
the second processing unit is configured to perform control for causing the in-vehicle equipment to operate based on the one mode indicated by the mode information.

5. The in-vehicle device according to claim 4, wherein the plurality of modes include a guest mode, which is a default setting among the plurality of modes, and an owner mode that is different from the guest mode, and
parameters based on which the in-vehicle equipment operates are set so that the number of first items that can be changed in the guest mode is less than the number of second items that can be changed in the owner mode.

6. The in-vehicle device according to claim 5, wherein all of the first items are included among the second items.

7. A communication system comprising:
the portable device according to claim 1; and
the in-vehicle device according to claim 4.

8. The communication system according to claim 7, wherein the first processing unit is configured to make a distinction between a guest mode, which is a default setting among the plurality of modes, and the plurality of modes other than the guest mode; and
wherein the plurality of modes include a guest mode, which is a default setting among the plurality of modes, and an owner mode that is different from the guest mode, and parameters based on which the in-vehicle equipment operates are set so that the number of first items that can be changed in the guest mode is less than the number of second items that can be changed in the owner mode.

9. The communication system according to claim 7, wherein the first processing unit is configured to make a distinction between a guest mode, which is a default setting among the plurality of modes, and the plurality of modes other than the guest mode; and
wherein all of the first items are included among the second items.
